(19) United States
(12) Patent Application Publication
(10) Pub. No.: US 2006/0055320 A1
(43) Pub. Date: Mar. 16, 2006

(54) LED panel LED display panel glue filling gateway

(75) Inventor: Ming-Shun Lee, Taipei (TW)

Correspondence Address: TROXELL LAW OFFICE PLLC, 5205 LEESBURG PIKE, SUITE 1404, FALLS CHURCH, VA, 22041, US

(73) Assignee: Taiwan Oasis Technology Co., Ltd.

(21) Appl. No.: 10/940,627

(22) Filed: Sep. 15, 2004

(51) Int. Cl. H01J 1/62; H01J 63/04

(52) U.S. Cl. 313/510

(57) ABSTRACT

One or multiple drainage being provided to the edge of an opening on the back of a display panel for each glue-filling gateway in each light emission area of a display to provide a ducking space for glue or gas in the course of glue filling to effectively prevent overflowing glue and air bulbs to further eliminate any protrusion or pit on the back of the display panel for securing a proper binding between the display panel and a substrate.

### BACKGROUND OF THE INVENTION

(a) Field of the Invention

The present invention is related to an improved construction of a numeric type LED display panel, and more particularly, to improved glue filling gateway construction used to inlay LED in display panel.

(b) Description of the Prior Art

By providing features of power saving, compact, not generating heat, long service life and immediate light emission not requiring warm-up, the light emission diode (LED) is gradually exiting the Christmas light strings, flashlights, traffic signs, and even the score boards otherwise dominated by the conventional light bulbs. It is expected for the LED to rapidly expand its market thanks to the ever-improving LED process technology helps significantly reduce the production cost of the LED and the presentation of a given light color by incorporating the light source from a chip and the wavelength of a fluorescent material (or by other means).

As illustrated in FIGS. 1 and 2 of the accompanying drawings, light source presentation from an LED is applied in an LED display. Wherein, a display 10 is essentially comprised of multiple light emission areas 111 provided on a display panel 11. Each light emission area 111 is arranged depending on the display effect attempted by the display 10 and is provided with a glue filling gateway 12 penetrating through the back of the panel 11 to facilitate the burial of a surface adhesion type of LED 20 in each light emission area 111 before being filled the glue 30 from the back of the panel 11 to firmly secure the LED 20 in the light emission area 111, and further to allow each light emission area 111 to achieve its expected presentation of the light source when the LED 20 is conducted.

However, the glue-filling gateway 12 of the display panel 11 of the prior art directly penetrates the back of the panel 11, and the excessive amount of glue 30 frequently overflows from the back of the panel 11 to form multiple protrusions thereon to compromise a proper binding between the display panel 11 and a substrate to further damage the operation efficacy of the display 10 as a whole.

### SUMMARY OF THE INVENTION

The primary purpose of the present invention is to provide an improved construction of the glue-filling gateway of an LED for assurance of proper binding between display panel and substrate. To achieve the purpose, similar to the prior art, multiple light emission areas are disposed on the display panel; each light emission area is arranged depending on the display result desired by the display. Each light emission area is provided with a glue-filling gateway penetrating through the back of the display panel to facilitate the burial of an a surface adhesion type of LED; and the glue is filled from the back of the display panel to firmly secure the LED in each light emission area.

In the present invention, one or multiple drainage is disposed to the edge of an opening on the back of the display panel to provide an ducking space for glue or gas present in the course of glue filling, thus to prevent creation of overflowing glue and air bulb for eliminating any protrusion or pit on the back of the display panel to secure a firm binding between the display panel and the substrate.

### BRIEF DESCRIPTION OF THE DRAWINGS

FIG. 1 is a front showing an LED panel of the prior art.

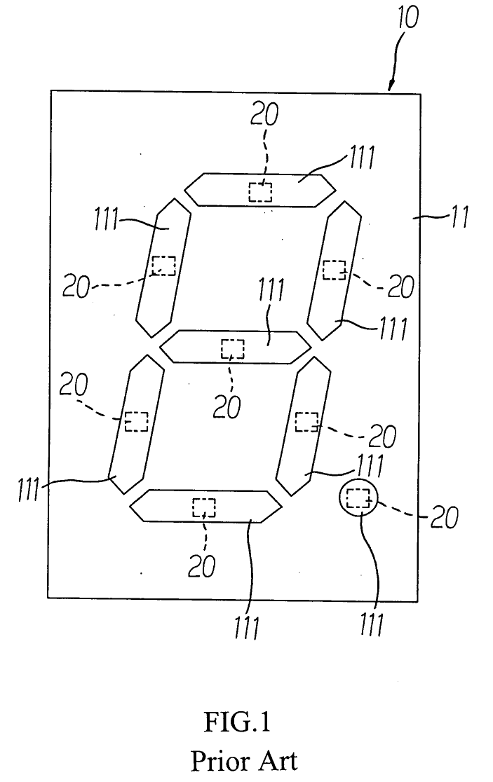

FIG. 2 is a sectional view of the LED panel of the prior art.

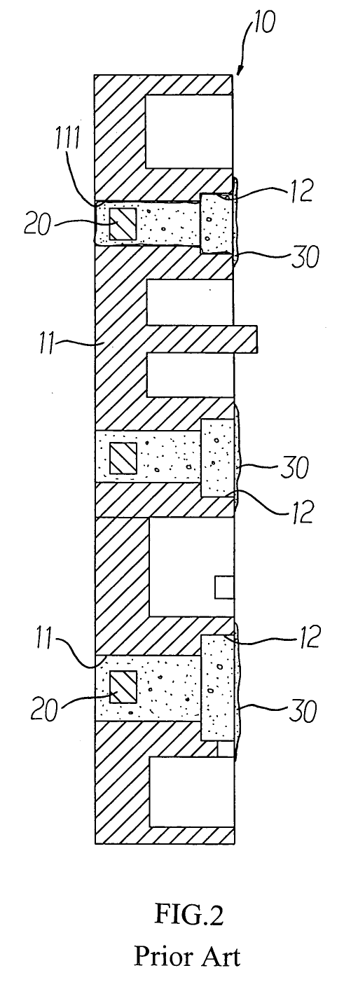

FIG. 3 is a schematic view showing a construction of the back of an LED panel of the present invention.

FIG. 4 is a schematic view showing a LED panel of the present invention.

### DETAILED DESCRIPTION OF THE PREFERRED EMBODIMENTS

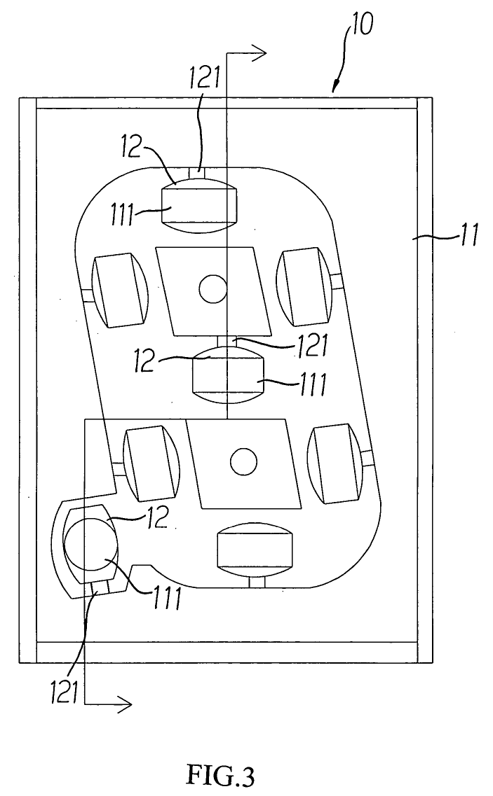

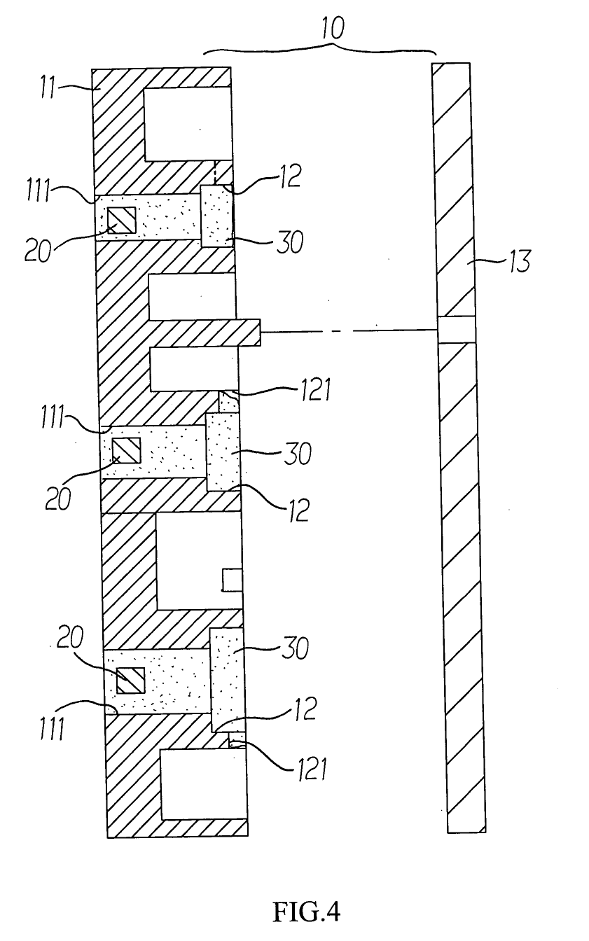

The present invention relates to an improved flue-filling gateway of an LED display. As illustrated in FIGS. 3 and 4, the display is essentially comprised of multiple light emission areas 111 disposed on a display panel 11 with each light emission area 111 arranged depending on the display results attempted by the display 10, and provided with a glue-filling gateway 12 penetrating through the back of the display panel 11 to facilitate the burial of a surface adhesion type of LED 20 to fill a glue 30 from the back of the display panel 11 for firmly securing the LED 20 in the light emission area 111; furthermore, a substrate 13 is bound to the back of the display panel 11 to conduct the LED 20 at a given time and sequent for the display 10 to present characters or patterns as expected.

One or multiple drainage is provided to the glue-filling gateway 12 of each light emission area 111 at the edge of an opening on the back of display panel 11 where the glue-filling gateway 12 is located. The drainage 121 directly extends to other cavities on the display panel 11.

Accordingly, in the course of glue filling, the drainage 121 provides a ducking space for the glue 30 or gas to prevent creating any overflowing glue and air bulbs, thus to eliminate any protrusion or pit for allowing the substrate 13 to properly bind to the display panel 11 for a normal function of the display 10.

Whereas the purpose of the drainage 121 is to provide a space for the glue to duck for the back of the display panel, each drainage 121 may be designed to extend for a fixed range or multiple drainages are connected to one another depending on the configuration of the structural space of the individual display panel.

The present invention by making available drainage to eliminate the problem of overflowing glue or gas found with the prior art provides an improved structure of a glue-filling gateway in an LED display. Therefore, this application for a utility patent is duly filed accordingly; however, it is to be noted that the preferred embodiments disclosed in the specification and the accompanying drawings are not limiting the present invention. Therefore, any construction, installation, or characteristics that is same or similar to that of the present invention should fall within the scope of the purposes and claims of the present invention.

I claim,

1. An LED display panel provided with multiple light emission areas with each disposed separately a glue-filling gateway penetrating through the back of the display panel is characterized by that one or multiple drainage is provided to the glue-filling gateway of each light emission area at the edge of an opening on the back of the display panel where the glue-filling gateway is located.

2. The LED display panel of claim 1, wherein, the drainage extends to other cavities on the display panel.

3. The LED display panel of claim 1, wherein, the drainage extends for a given range.

4. The LED display panel of claim 1, wherein, multiple drainages are connecting through one another.

5. The LED display panel of claim 1, wherein, the LED buried in each light emission area relates to a surface adhesion type of LED.

6. An improved glue-filling gateway for an LED having provided multiple light emission areas on a display panel with each provided with a glue-filling gateway penetrating through the back of the display panel, an LED being fixed by the glue and buried in each light emission area, and a substrate being provided to the back of the display panel is characterized by that one or multiple drainage being provided to the glue-filling gateway of each light emission area at the edge of an opening on the back of the display panel where the glue-filling gateway is located.
